(19) United States
(12) Patent Application Publication
(10) Pub. No.: US 2013/0185875 A1
(43) Pub. Date: Jul. 25, 2013

(54) Loading Ramp With Lift Assist

(71) Applicants: Fred Jevaney, Elmhurst, IL (US); Eric Colborn, Elmhurst, IL (US); Chris Sulocha, Elmhurst, IL (US)

(72) Inventors: Fred Jevaney, Elmhurst, IL (US); Eric Colborn, Elmhurst, IL (US); Chris Sulocha, Elmhurst, IL (US)

(21) Appl. No.: 13/734,388

(22) Filed: Jan. 4, 2013

Related U.S. Application Data
(60) Provisional application No. 61/584,116, filed on Jan. 6, 2012.

(51) Int. Cl. B60P 1/43

(52) U.S. Cl. CPC B60P 1/43
USPC 14/71.7; 14/69.5

(57) ABSTRACT

A lift assist for a loading ramp includes two biasing mechanisms that cooperate to bias the loading ramp from a stored position under a truck to a working position that engages the truck bed. One biasing mechanism is a mechanical bias, such as a coiled spring. The other biasing mechanism is a hydraulic bias, such as a gas spring.

### CROSS-REFERENCE TO RELATED APPLICATION

This application claims the benefit of U.S. Provisional Application No. 61/584,116, filed Jan. 6, 2012, which is incorporated by reference in its entirety.

### FIELD

The present invention relates to loading ramps that are used to facilitate the loading and unloading motor vehicles, such as trucks.

### BACKGROUND

Loading ramps are used to load and unload cargo from a delivery truck. They provide a long flat surface that extends at a gradual downward slope from the back end of the truck to the ground level. Loading ramps should be easy to move from a stored position to a working position and should be sufficiently strong when in the working position. The ramp may be detached from the rear of the truck and stored under the vehicle body, or inside the truck, when not in use.

Loading ramps can be heavy. Lifting the ramp from a stored position under the truck to a working position located at the working level of vehicle cargo area can be difficult. Lift assists can be used to reduce the effort needed to lift the ramp into its working position. Existing lift assists, however, suffer from several shortcomings, including a lack of lifting force during certain points in the lifting process.

One example of a lift assist is disclosed in U.S. Pat. No. 5,340,267 to Stoll. The Stoll patent discloses a lift assist that relies solely upon a compression spring to bias the loading ramp into position. The lift assist of the Stoll patent, however, does not provide sufficient biasing force across a portion of its range of motion. Thus, there exists a need for a lift assist that provides a lifting force during a greater range of motion than provided by existing lift assists.

### BRIEF SUMMARY

A loading ramp that includes a platform and a lift mechanism is provided. The platform includes a panel and two side rails and the panel is disposed between the side rails. The lift mechanism is attached to the platform and includes a mechanical lift mechanism and a hydraulic lift mechanism. The mechanical lift mechanism may be a coiled spring and the hydraulic lift mechanism may be a gas spring.

In another embodiment, the loading ramp includes a frame that is capable of being mounted to a vehicle and a linkage. The linkage has a first end and a second end. The first end of the linkage is pivotally connected to the ramp and the second end of the linkage is engaged with a frame mounted under the vehicle.

In another embodiment, a method of biasing one end of a loading ramp from a first position to a second position that is higher than the first position is provided. The method includes providing a mechanical lift mechanism that applies a first biasing force to the end of the loading ramp, and providing a hydraulic lift mechanism that applies a second biasing force to the end of the loading ramp.

### BRIEF DESCRIPTION OF THE DRAWINGS

FIG. 1 is a perspective view of a loading ramp with a lift mechanism of the present disclosure;

FIG. 2 is a perspective view of a loading ramp with a lift mechanism of the present disclosure;

FIG. 3 is a perspective view of a loading ramp with a lift mechanism of the present disclosure;

FIG. 4 is a perspective view of a loading ramp with a lift mechanism of the present disclosure; and,

FIG. 5 is a perspective view of a loading ramp with a lift mechanism of the present disclosure.

### DETAILED DESCRIPTION OF THE DISCLOSED EMBODIMENTS

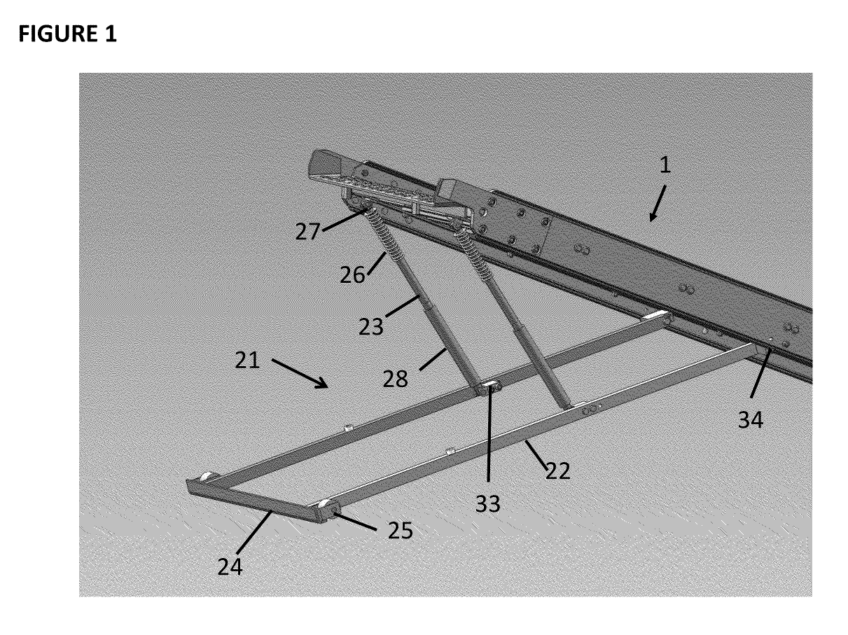

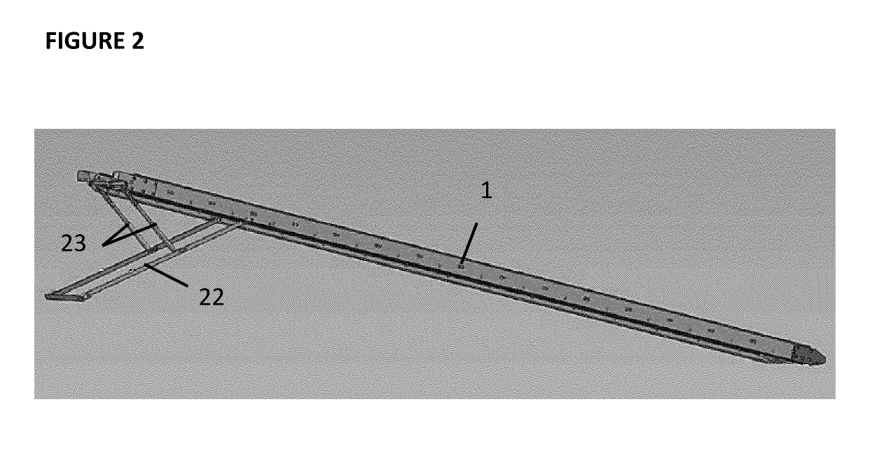

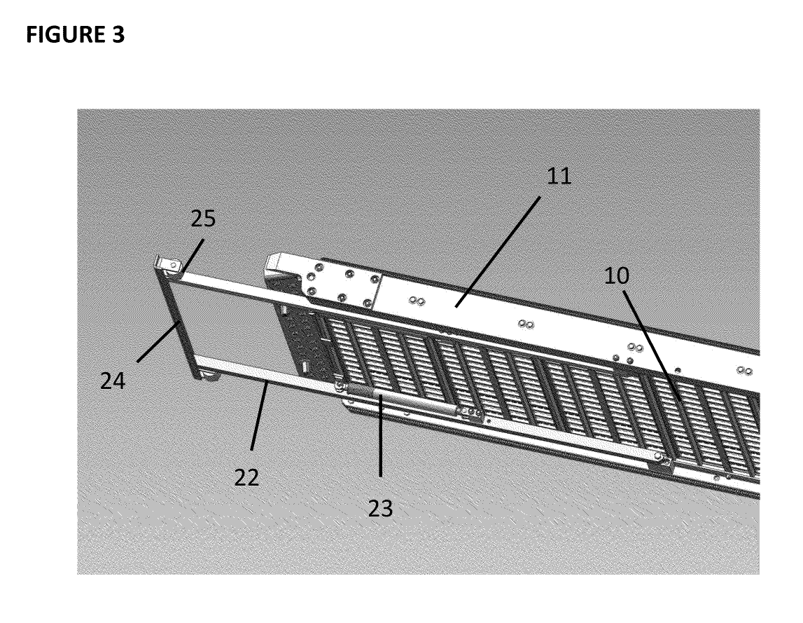

A loading ramp 1 with an attached lift mechanism 21 is shown in FIGS. 1-5. As shown in FIG. 3, the loading ramp 1 includes several panels 10 mounted between a pair of opposing side rails 11. The rails may be formed of metal, such as extruded or cast aluminum. The panels 10 may be formed of metal as well by known techniques, including extrusion or casting. The panels 10 are secured in the side rails 11 by bolts and nylock nuts. The panels are further secured by channels formed in the side rails 11. The panels 10 comprise a latticework of openings. The panels 10 also includes points that provide an anti-slip surface that helps avoid slips when a user is walking on the panels 10.

As shown in FIG. 1, the lift mechanism 21 includes a linkage 22 and two biasing mechanisms 23. Each structure will be described in detail in the following paragraphs.

The biasing mechanisms 23 include two types of biasing elements, a mechanical bias 26 and a hydraulic bias 27. One type of biasing element that is included in the biasing mechanisms 23 is a mechanical bias 26. In the embodiment of FIG. 1, the mechanical biasing element is a coiled spring 26. The coiled spring may be of any size and material that provides sufficient force to assist the lifting of the ramp 1 into the active position. The coiled spring 26 of the disclosed embodiment is a compression spring with a 1.10 inch outer diameter, is made of 0.148 inch wire and is 5 inches long.

The biasing mechanism 23 also includes a hydraulic bias. In the embodiment of FIGS. 1-5, the hydraulic bias is a gas spring 27. The gas spring 27 of the present disclosure is disposed within the coiled spring 26 and a sleeve 28, as shown in FIG. 1. The gas spring may be of any size and material that provides sufficient force to assist the lifting of the ramp 1 into the active position. The gas spring 27 of the present disclosure has a diameter of 0.708 inches, an 8 inch stroke and is rated at 85 pounds.

The biasing mechanisms 23 are attached to the ramp 1 and the linkage 22 as follows. In the embodiment of FIG. 1, a block 33 is bolted to each linkage 22. The block 33 includes a cut-out that accommodates one end of the biasing mechanism 23 and a hole that accommodates a cleavis pin that engages the end of the biasing mechanism and secures it in place. The other end of the biasing mechanisms are rotatably bolted to the end of the ramp, as shown in FIG. 1. Likewise, the end of the linkages 22 that do not include the wheels 25 are rotatably bolted to blocks 34 that are attached to the ramp 1.

The use of two different types of biasing elements provides a complementary action because they provide peak lifting power during different points in the range of motion as the ramp is lifted from a stored position to an active position. When the two biasing elements are combined, they provide peak lifting power through a larger total range of motion. For example, the coiled spring 26 provides peak lifting power during the initial lifting stage and the gas spring 27 provides peak lifting power during the subsequent lifting stage.

The lift mechanism 21 is mounted to the loading ramp as shown in FIG. 1. Each linkage 22 extends from a side rail 11 of the loading ramp 1 to opposing sides of an end rail 24 of the lift mechanism. Attached to the end rail 24 are wheels 25 that slide within a frame mounted under a delivery truck. The wheels 25 of the disclosed embodiment are made of nylon. The linkage 22 and end rail 24 are made of steel.

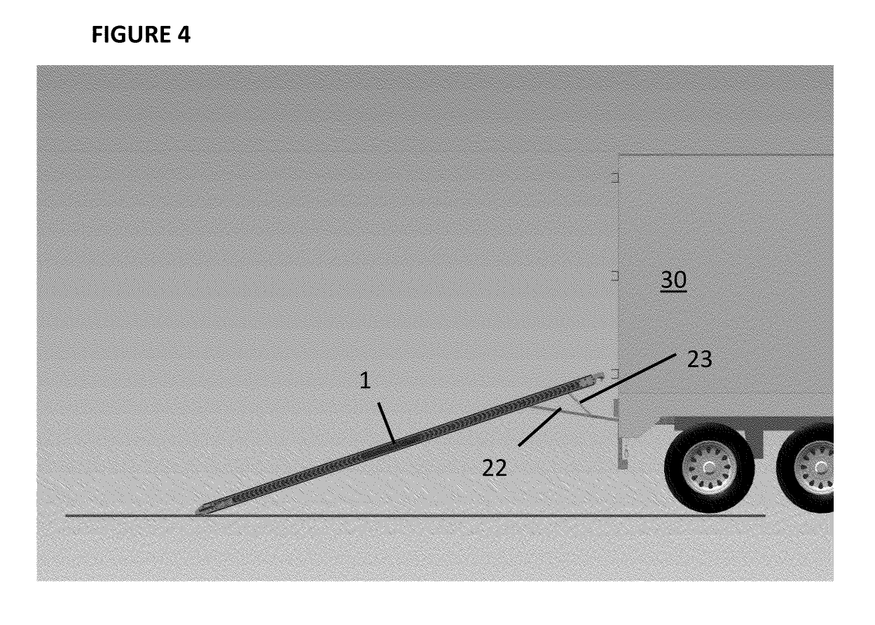

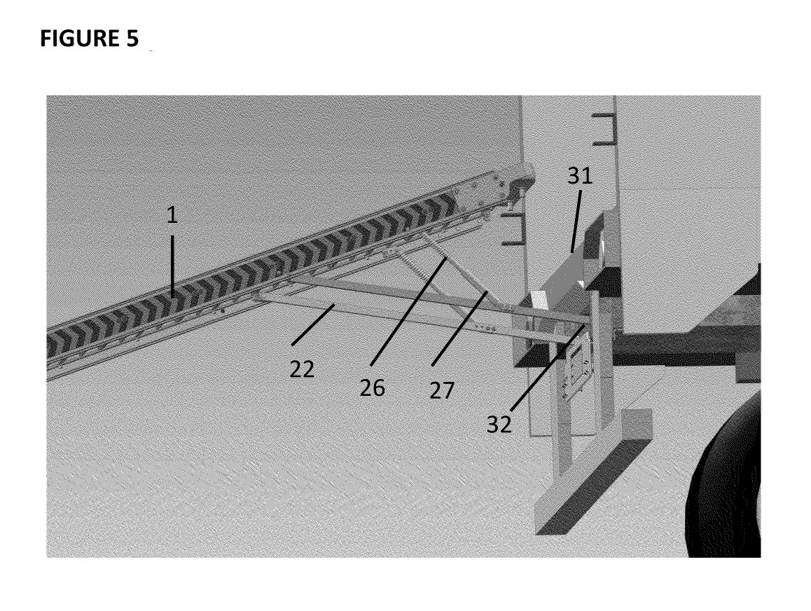

Another embodiment is shown in FIGS. 4 and 5. In the embodiment shown in FIGS. 1-3, the biasing force created by the biasing mechanism 23 is directed generally away from the truck. However, in the embodiment of FIGS. 4 and 5, the biasing mechanisms 23 are mounted so that the biasing force is directed generally toward the truck. The construction and operation of the biasing mechanisms in FIGS. 4 and 5 is identical to the biasing mechanisms in FIGS. 1-3 in all other respects.

FIGS. 4 and 5 disclose how the loading ramp and lift mechanism are attached to and interact with a truck. The truck 30 includes a cargo area. The floor 31 of the cargo area is a work surface for holding cargo. The present invention may be used with a variety of different vehicles. The truck also includes a frame 32 mounted under the truck for securing the ramp when not in use. The frame 32 includes a pair of opposing channels that engage and retain the loading ramp 1 and lift mechanism 21. The interaction between the loading ramp 1, the lift mechanism 21 and the frame 32 is shown in FIGS. 4 and 5. Such structures are known in the art and are described, for example, in U.S. Pat. No. 5,340,267 to Stoll.

In general, the frame 32 is configured to receive and store the entire ramp 1 and lift mechanism 21 when the ramp is not in use. When an operator wishes to use the ramp, the operator pulls the ramp from underneath the delivery truck. The ramp slides within the frame 32 until the end of the ramp 1 is clear of the back end of the truck. At that point, the linkage 22, end rail 24 and wheels 25 continue to engage and be retained within the frame so that the ramp does not fall to the ground. The wheels 25 facilitate the sliding of the ramp in and out of the frame 32.

When the end of the ramp 1 is clear of the back end of the truck, it may be lifted into position on the back end of the truck with the help of the biasing force provided by the lift mechanisms 21. The lift assist reduces the amount of force necessary for the operator to lift the end of the ramp onto the bed of the truck. The mechanical and hydraulic biasing elements provide complementary biasing forces to that a biasing force helps lift the ramp over a greater range of motion. In particular, as the mechanical biasing element reaches its free length and exerts little or no biasing force, the hydraulic biasing means will still be providing at least some biasing force, preferably a force that is greater than the force being exerted by the mechanical biasing element.

The biasing forces for each biasing element may be selected and tailored to the particular application and loading ramp. For example, in some applications it may be desirable for the biasing force of the mechanical biasing element to be greater than the biasing force of the hydraulic biasing element at the beginning of the range of motion. Alternatively, in other applications it may be desirable for the biasing force of the mechanical biasing element to be less than the biasing force of the hydraulic biasing element at the beginning of the range of motion. The same concepts may be applied to selecting the biasing forces that exist at the end of the range of motion of the lift mechanism.

The disclosed embodiments are exemplary only and do not limit the scope of the invention.

1. A loading ramp with lift assist comprising:
a. a platform, the platform including a panel and two side rails, the panel being disposed between the side rails; and
b. a lift mechanism, wherein the lift mechanism is attached to the platform and comprises a mechanical lift mechanism and a hydraulic lift mechanism.

2. The loading ramp of claim 1, wherein the mechanical lift mechanism is a coiled spring.

3. The loading ramp of claim 1, wherein the hydraulic lift mechanism includes a gas spring.

4. The loading ramp of claim 3, wherein the hydraulic lift mechanism includes a gas spring.

5. The loading ramp of claim 1, further comprising a linkage, wherein the linkage has a first end and a second end, the first end of the linkage is pivotally connected to the platform and the second end of the linkage is capable of engaging a frame that is mounted to a vehicle.

6. The loading ramp of claim 5, wherein the platform has a distal end that may be attached to a vehicle, and the lift mechanism has a first end and second end, the first end of the lift mechanism is attached to the linkage and the second end of the lift mechanism is attached to the platform at a location proximate the distal end of the platform.

7. A method of biasing one end of a loading ramp from a first position to a second position that is higher than the first position, the method comprising:
a. providing a mechanical lift mechanism, the mechanical lift mechanism being connected to the loading ramp and applying a first biasing force to the end of the loading ramp; and,
b. providing a hydraulic lift mechanism, the hydraulic lift mechanism being connected to the loading ramp and applying a second biasing force to the end of the loading ramp.

8. The method of claim 7, wherein the first biasing force decreases as the loading ramp moves from the first position to the second position.

9. The method of claim 7, wherein the first biasing force is greater than second biasing force when the loading ramp is in the first position.

10. The method of claim 7, wherein the second biasing force is greater than the first biasing force when the loading ramp is in the second position.

11. The method of claim 9, wherein the second biasing force is greater than the first biasing force when the loading ramp is in the second position.

12. The method of claim 7, wherein the mechanical lift mechanism is a coiled spring.

13. The method of claim 7, wherein the hydraulic lift mechanism is a hydraulic spring.

14. The method of claim 7, wherein:
c. the mechanical lift mechanism is a coiled spring;
d. the hydraulic lift mechanism is a hydraulic spring; and,
e. the second biasing force is greater than the first biasing force when the loading ramp is in the second position.
